(19) United States
(12) Patent Application Publication
(10) Pub. No.: US 2012/0318209 A1
(43) Pub. Date: Dec. 20, 2012

(54) Tug Toy With Hand Guard

(75) Inventors: Tristan Christianson, San Francisco, CA (US); Patrick De Rosa, San Francisco, CA (US)

(73) Assignee: ABSOLUTELYNEW, INC., San Francisco, CA (US)

(21) Appl. No.: 13/315,138

(22) Filed: Dec. 8, 2011

Related U.S. Application Data
(60) Provisional application No. 61/421,530, filed on Dec. 9, 2010.

(51) Int. Cl. A01K 29/00

(52) U.S. Cl. 119/707

(57) ABSTRACT

A tug of war toy with a hand guard on the handle portion of the toy. The hand guard provides protection to the user's hands from accidental biting during play with the pet.

### CROSS-REFERENCE TO RELATED APPLICATIONS

61/421,530

### FEDERALLY SPONSORED RESEARCH

None

### SEQUENCE LISTING

None

### BACKGROUND OF THE INVENTION

Tug toys for pets have been used for years and are well known means for a pet owner to interact with his or her pets. It is well known that interactive play between a pet and the owner is extremely beneficial to both the pet and the owner. This type of interaction provides exercise, training and sensory stimulation for the pet, and develops a strong emotional bond between the pet and the owner.

However, some owners are reluctant to play tug of war with their pets because they are concerned about accidental bites that can cause significant injuries to their hands. Pets with more aggressive personality or larger sized pets pose higher risk of serious injury to the owner's hands when accidental bites occur. Thus, it is desirable for a form of hand guard on the handle of a tug of war pet toy to protect the owner from injuries, as well as to significantly reduce the risk of accidental bites coming from the pet.

### SUMMARY OF THE INVENTION

In view of the foregoing disadvantages inherent to the known types of tug of war toys now present in the prior art, the present invention provides a new tug of war toy construction that allows adequate protection to the person's hand when playing tug of war with a domestic pet.

The general purpose of the present invention, which will be described subsequently in greater detail, is to provide a better protection to the hands of a person playing tug of war with a domestic pet and minimize if not eliminate completely the risk of accidental bites from enthusiastic pets.

To attain this, the present invention generally comprises a tug of war toy with a hand guard located between the handle and the tugging object. The hand guard provides protection to the user's hands from accidental biting during play with the pet.

There has thus been outlined, rather broadly, the more important features of the invention in order that the detailed description thereof that follows may be better understood and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of the construction and to the arrangements of the components set forth in the following description or illustrated in the drawings. The invention is capable of other embodiments and of being practiced and carried in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially to the practitioners in the art who are not familiar with patent or legal terms or phraseology, to determine quickly from a cursory inspection of the nature and essence of the technical disclosure of the application. The abstract is neither intended to define the invention of the application, which is measured by the claims, nor is it intended to be limiting as to the scope of the invention in any way.

It is therefore an object of the present invention to provide a new tug of war toy apparatus which has many of the advantages of the tug of war toys mentioned heretofore and novel features that result in a new tug of war toy which is not anticipated, rendered obvious, suggested, or even implied by any of the prior art, either alone or in any combination thereof.

It is another object of the present invention to provide a new tug of war toy which may be easily and efficiently manufactured and marketed.

It is a further another object of the present invention to provide a new tug of war toy which is of a durable and reliable construction.

An even further object of the present invention is to provide a new tug of war toy which is susceptible of a low cost of manufacture with regard to both materials and labor, and which accordingly is then susceptible of low prices of sale to the consuming public, thereby making such tug of war toy economically available to the buying public.

Still yet another object of the present invention is to provide a new tug of war toy which provides in the apparatuses and methods of the prior art some of the advantages thereof, while simultaneously overcoming some of the disadvantages normally associated therewith.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### DETAILED DESCRIPTION OF THE INVENTION

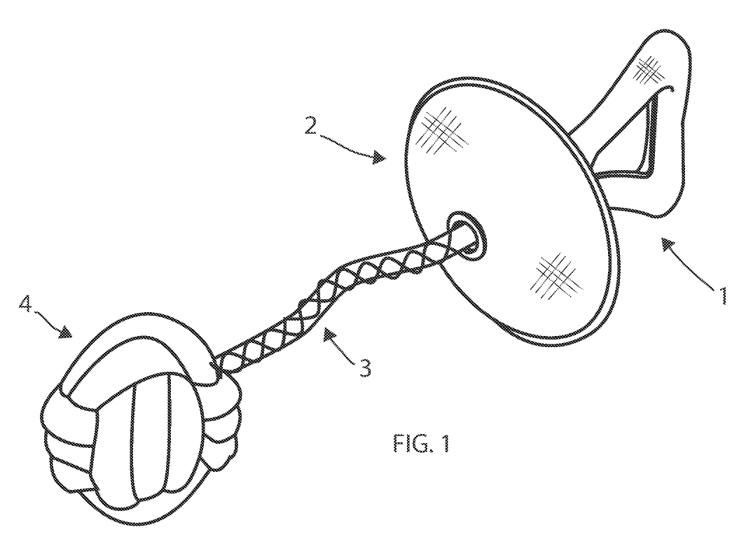

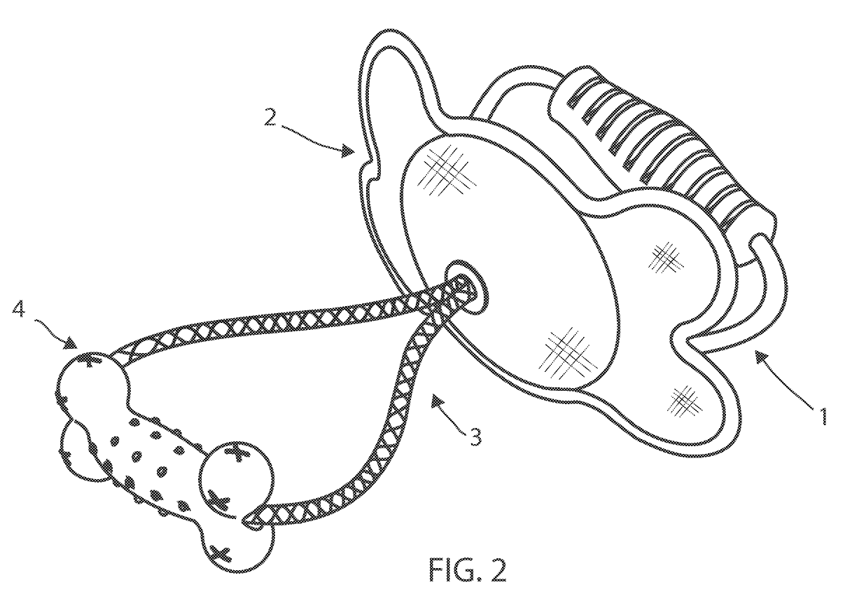

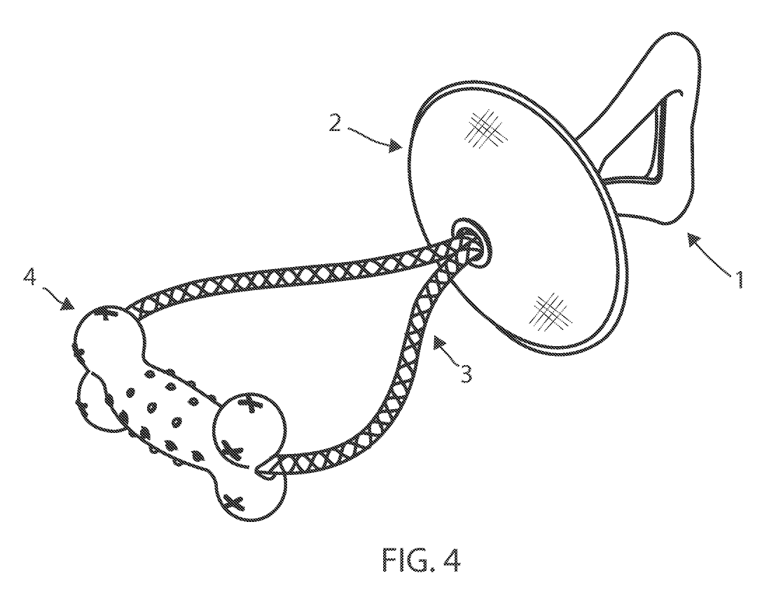

FIGS. 1-4 show nonexclusive illustrative examples of the tug of war toy embodiments. The invention has four essential components: a handle 1, a hand guard that acts as a shield to protect the user's hand from accidental bites 2, a flexible tensile connecting member 3, and a tugging object 4 at the other end of the toy for the domestic pet to bite and hold on to. The handle 1 can be shaped in several different configurations, including but not limited to a looped handle, T-shaped handle, sword grip handle, and pistol grip handle.

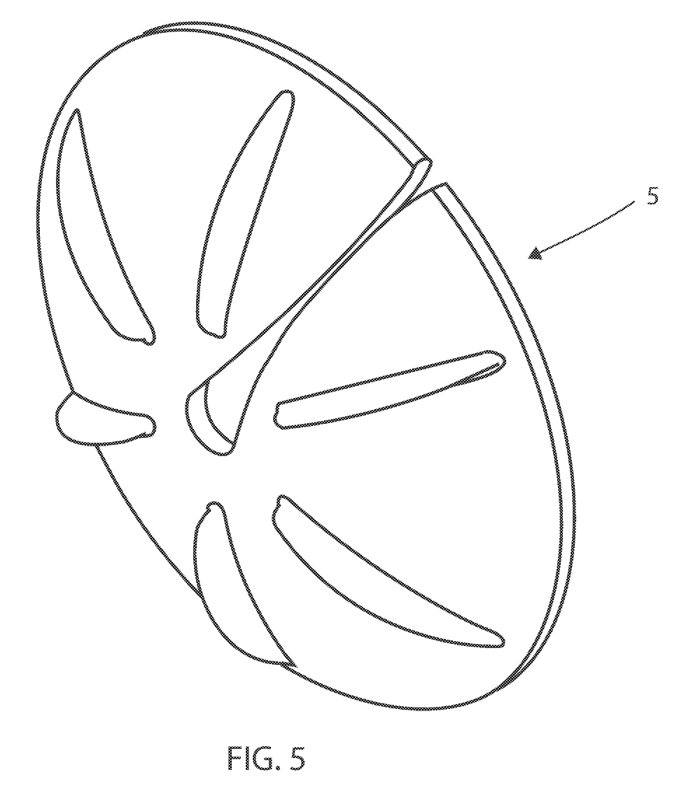

The hand guard 2 is located between the handle 1 and the tugging object 4. In the preferred embodiment, said hand guard 2 is a non-separable piece from the toy, but is a separate piece from the handle such that the user can adjust the position of the hand guard 2 relative to the handle 1. Nonetheless, it should be clear to someone skilled in the art that the handle 1 and the hand guard 2 is embodied as a one piece component. Yet another alternative embodiment of the hand guard 2 is as a separable piece that can be detached from the handle by the user, or can be added to an existing tug of war toy that does not come with a hand guard, as seen on FIG. 5.

The preferred embodiment of the hand guard material would be ballistic nylon, but other similar materials known in the art would be acceptable as well. The hand guard 2 can also be made from a solid piece insert into the fabric, similar to the idea of insert plate armor in conventional ballistic protection vests.

The shape of the hand guard 2 can be as simple as a flat circular plate with a diameter of roughly between four and six inches, enough to cover the size of an average adult hand holding the handle. In a more elaborate protective design, the hand guard 2 can be shaped as a bell shaped or basket shaped hilt design, similar to common hand guard designs found in swords.

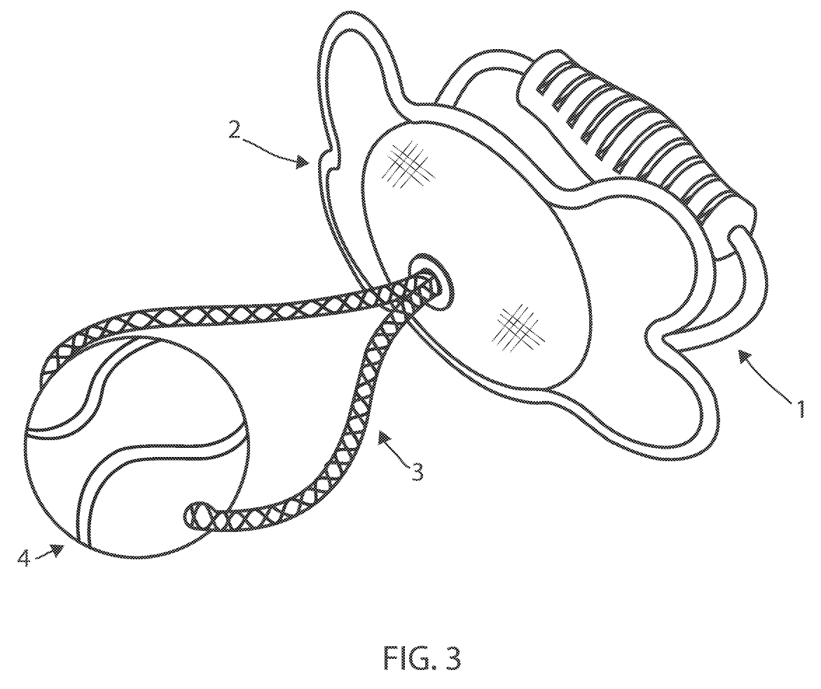

The tugging object 4 is made of preferably a tough yet elastic material, for safety purposes for both the pet and the person using the toy. The tugging object 4 is connected to the handle 1 and hand guard 2 by an flexible tensile connector 3, which in the preferred embodiment is rope made of nylon fiber. One embodiment of the tugging object 4 would be a nylon rope formed into a monkey fist knot as seen in FIG. 1. Another embodiment of the tugging object would be a tennis ball seen in FIG. 3, a familiar object well known to domesticated pets for play use. An alternative embodiment is presented as a tugging object 4 being separable from the elastic rope 3 by means of attachment and fastening well known in the art. In order to accommodate multiple pets playing at the same time, the tug of war toy can have multiple tugging objects 4 attached to the handle.

Interchangeable versions of the hand guard, handle, rope and tugging object might be supplied with each tug toy to allow the pet and owner tremendous variety in the toy due to the number of possible permutations of the tug toy components. Alternative embodiments of the invention can also encompass ornamental designs based on famous or popular characters and shapes, such as cartoon characters, sport mascots, and the like.

As to further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A tug of war toy, comprising of:
a. A handle;
b. At least one or more tugging objects;
c. A tensile connecting member that connects said handle to said tugging object; and
d. At least one hand guard, located between said handle and said tugging object.

2. A tug of war toy of claim 1, where the hand guard is a detachable piece.

3. A tug of war toy of claim 1, where the tensile connecting member is made of nylon fiber.

4. A tug of war toy of claim 1, where said tugging object is a monkey's fist type knot.

5. A tug of war toy of claim 1, where said tugging object is a tennis ball.

6. A tug of war toy of claim 1, where there are more than one tugging objects are connected to said handle.

7. A tug of war toy of claim 1, where said handle is a T-shaped handle.

8. A tug of war toy of claim 1, where said handle is a pistol grip handle.

9. A tug of war toy of claim 1, where said handle is a sword grip handle.

10. A tug of war toy, comprising of:
a. A handle;
b. At least one or more tugging objects;
c. A tensile connecting member that connects said handle to said tugging object;
d. A hand guard; where said hand guard is integrated to said handle.

11. A tug of war toy of claim 10, where the hand guard is a detachable piece.

12. A tug of war toy of claim 10, where the tensile connecting member is made of nylon fiber.

13. A tug of war toy of claim 10, where said tugging object is a monkey's fist type knot.

14. A tug of war toy of claim 10, where said tugging object is a tennis ball.

15. A tug of war toy of claim 10, where there are more than one tugging objects are connected to said handle.

16. A tug of war toy of claim 10, where said handle is a T-shaped handle.

17. A tug of war toy of claim 10, where said handle is a pistol grip handle.

18. A tug of war toy of claim 10, where said handle is a sword grip handle.
